(19) United States
(12) Patent Application Publication
(10) Pub. No.: US 2009/0295138 A1
(43) Pub. Date: Dec. 3, 2009

(54) SEAT BELTS

(76) Inventors: Graham Edward Cox, Manchester (GB); Ronald Sydney Cox, Basingstoke (GB)

Correspondence Address: MICHAEL BEST & FRIEDRICH LLP, 100 E WISCONSIN AVENUE, Suite 3300, MILWAUKEE, WI, 53202, US

(21) Appl. No.: 12/362,283

(22) Filed: Jan. 29, 2009

(30) Foreign Application Priority Data
May 29, 2008 (GB) 0809751.1

(51) Int. Cl. B60R 22/00; B23P 11/00

(52) U.S. Cl. 280/801.1; 29/700

(57) ABSTRACT

A cover to envelop a plastic part of a seat belt tongue of a seat belt. The cover uses an elastically deformable body to allow it to be easily fitted and removed from the tongue.

### BACKGROUND OF THE INVENTION

The present invention relates to covers for seat belts and methods of covering seat belts.

FIG. 1 shows a typical configuration of a known vehicle seat belt SB comprising a webbing W, an inertia reel I, a B-pillar BP, a tongue T, a buckle B and an end bracket EB. The webbing W is retractably connected to the inertia reel I, and extends from the inertia reel I up through the B-pillar BP, usually positioned adjacent to a user's shoulder, and then through the tongue T to the end bracket EB. The buckle B is usually positioned adjacent to a user's hip on the opposite side of the user to the B-pillar BP.

FIG. 2 shows a typical tongue T for engaging with the buckle B. The tongue T comprises a piece of plastic P moulded around a stainless extension E. To use the seat belt SB a user grasps the tongue T (usually the plastic part P thereof) to draw the webbing W from the inertia reel I. The user then fastens the tongue T to the buckle B using the extension E.

A problem with seat belts is that tongues, such as the one shown in FIG. 2, can slip from a user's grasp as they are being drawn towards the buckle B.

Another problem with seat belts is that at night the tongue and buckle can be difficult to locate. This may lead to a user driving without the seat belt apparatus SB being securely fastened, which is potentially dangerous and illegal.

A further problem with known seat belts is that if the vehicle in which the seat belt SB is located has a number of different users, infections may be transmitted by users touching the seat belts, in particular, the tongues T.

Another problem is that often the inertia reel I does not fully retract the tongue T before a user closes a door of a car, which can result in the tongue T being trapped between the door and the door frame thereby damaging the car.

Another problem is that seat belts are increasingly seen by, for example, rebellious adolescents as conforming to the norm leading to them to not wear the seat belt thereby putting themselves at risk of injury.

### SUMMARY OF THE INVENTION

It is an aim of an embodiment of the present invention to address problems associated with seat belts, whether identified herein or otherwise.

According to the present invention there is provided apparatus and a method as set forth in the appended claims. Other features of the invention will be apparent from the dependent claims, and the description which follows.

According to the present invention in a first aspect, there is provided a cover for a seat belt tongue, the cover having: an elastically deformable body having means for holding the cover on the seat belt tongue.

The seat belt tongue may be the originally manufactured seat belt tongue or may be a seat belt tongue that has been modified or adapted by a user post-manufacture. The modification or adaptation of the seat belt tongue may include an attachment of an additional part to the seat belt tongue, wherein the cover may be adapted to cover at least part of the additional part.

The deformable body may be stretched, in use, to be elastically fitted to the seat belt tongue.

Suitably, the means for holding has a first hooked portion for hooking around the seat belt tongue to hold the cover in position. Suitably, the means for holding has a second hooked portion. Suitably, the first and/or second hooked portion is elastically deformable to fit around a seat belt tongue.

Suitably, the first and second hooked portions are located at opposite end regions of the body.

Suitably, the means for holding has a channel for receiving and holding the seat belt tongue.

Suitably, in use, the channel is arranged to hold an edge region of the seat belt tongue and the hooked portion is, or the first and second hooked portions are, arranged to hold the opposite edge region of the seat belt tongue.

Suitably, the means for holding has a securement means for, in use, holding the cover on the tongue. Suitably, the securement means is located in end regions of the first and second hooked portions. Suitably, the securement means has a strap and a fastening means to hold the cover on the tongue. Suitably, the fastening means includes an aperture on the strap and a protrusion extending from one of the hooked portions; wherein the protrusion is located through the aperture to secure the strap.

Suitably, the body has a first textured region for being gripped by a user. Suitably, the first textured region has a compressible element. Suitably, the first textured region has an elastically compressible element. Suitably, the first textured region has a plurality of compressible elements. Suitably, the or each compressible element is a protrusion extending from the body. The or each protrusion may be one of a nodule, a rib or a ridge.

Suitably, the body has a second textured region distinct from the first textured region. Suitably, the second textured region has the features described for the first textured region.

Suitably, the first and second textured regions are separated by a non-textured region. Suitably, first and second textured regions are arranged at an edge region of the body. Suitably the non-textured region is provided in region over which the webbing of seat belt will run when the cover is in place on a seat belt tongue.

Suitably, the body comprises a rubber-like material. Alternatively, or in addition, the body comprises a pliable plastics material. Suitably, the body comprises a silicone material.

Suitably, at least part of the cover has a bactericidal coating. Suitably, all the cover has a bactericidal coating.

Suitably, the at least part of the cover is impregnated with a bactericidal substance. Suitably, all the cover is impregnated with a bactericidal substance.

The bactericidal substance may be ethyl alcohol

Suitably, the cover has a luminous, fluorescent or reflective body.

Suitably, the cover has a pressure activated system; wherein the pressure activated system senses a user touching the cover. Suitably, in use, the cover emits a sound in response to a user's touch being sensed. Suitably, the sound is a voice sound. Suitably, the voice sound is a safety warning. Alternatively, or in addition the cover lights-up in response to a user's touch being sensed.

Suitably, the cover is dimensioned to cover a substantial part of a seat belt tongue when in place thereon. Suitably, the cover is dimensioned to cover more than 50% of the exterior of the seat belt tongue when in place thereon.

Suitably, the cover is shaped and dimensioned to allow the seat belt tongue to be moved relative to a webbing of a seat belt when in place or a seat belt tongue.

According to the present invention in a second aspect, there is provided a seat belt tongue comprising a cover having a deformable body having means for holding the cover on the seat belt tongue, wherein the body is elastically fitted to the seat belt tongue.

The cover may, in use, have an additional part attached to the seat belt tongue and the cover is adapted to cover at least part of the seat belt tongue and the additional part.

Suitably, the cover is a cover as described for the first aspect.

According to the present invention in a third aspect, there is provided a method of covering a seat belt tongue, the method having the steps of: selecting a cover having a deformable body, wherein the deformable body has means for holding the cover on the seat belt tongue; and elastically fitting the deformable body to the seat belt tongue.

Suitably, the step of elastically fitting involves: stretching the deformable body to fit over the seat belt tongue; arranging the deformable body to cover part of the seat belt tongue; and releasing the deformable body elastically hold the cover on the seat belt tongue.

Suitably, the step of elastically fitting involves: hooking the cover around the tongue to hold the cover in position. Suitably, the step of hooking involves hooking a first hooked portion of the body around the tongue. Suitably, the step of hooking involves hooking a second hooked portion of the body around the tongue.

Suitably, the step of elastically fitting involves inserting the tongue into a channel provided in the body.

Suitably, the step of elastically fitting involves inserting an end region of the tongue into the channel and hooking the first and/or second hooked portions around an opposed end regions of the tongue.

Suitably, the cover is elastically fitted to cover only part of the seat belt tongue. Suitably, the cover is elastically fitted to a plastic part of the seat belt tongue. Suitably, the cover is arranged to allow the tongue to be moved relative to a webbing of a seat belt associated with the tongue.

Suitably, the selected cover has a securement means to secure the cover to the seat belt tongue, in use. Suitably, the securement means includes a strap and a fastening means; wherein the strap is connectable to the fastening means to secure the cover. Suitably, the selected cover has a plurality of straps and a plurality of fastening means.

According to the present invention there is provided an apparatus and method as set forth in the appended claims. Other features of the invention will be apparent from the dependent claims, and the description which follows.

### BRIEF DESCRIPTION OF THE DRAWINGS

The present invention may be carried out in practice in various ways but a first and several alternative embodiment will now be described, by way of example and with reference to the accompanying drawings, in which:

FIG. 1 shows a typical known seat belt apparatus;

FIG. 2 shows a typical known seat belt tongue;

FIG. 3 shows a perspective view of a cover according to a first embodiment of the present invention;

FIGS. 4a and 4b show a front view of a cover of FIG. 3 before and after being positioned on a seat belt tongue;

FIG. 5 shows a front view of a cover according to a second embodiment of the present invention;

FIGS. 6a-6d show front views of further alternative embodiments of the present invention; and

FIG. 7 shows a further example of a seat belt apparatus to which the cover is attachable.

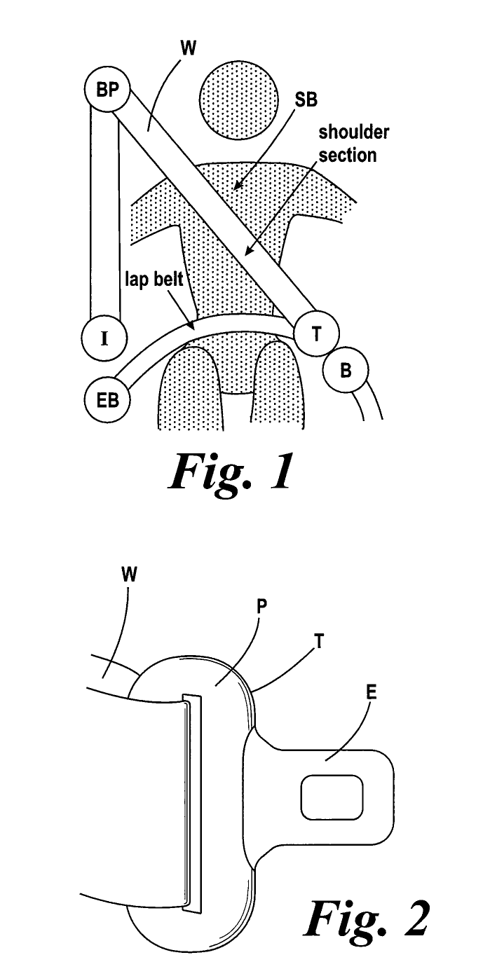

### DETAILED DESCRIPTION

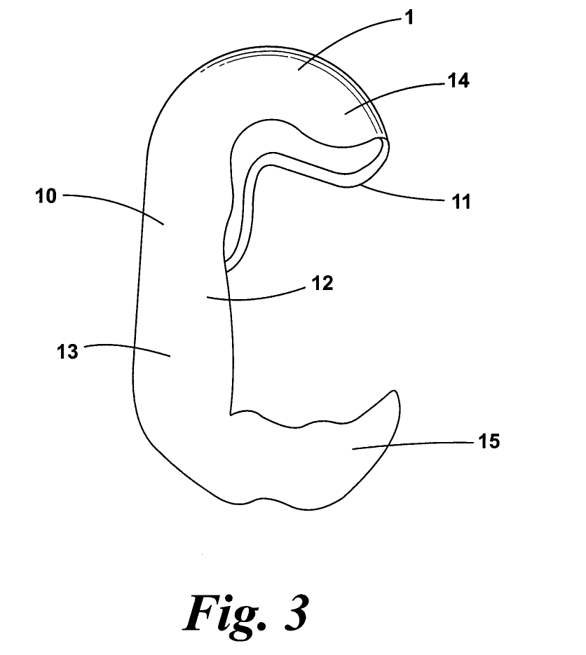

FIG. 3 shows a cover 1 for covering a seat belt tongue T. The cover 1 has an elastically deformable body 10 to allow it to be easily fitted to and removed from a tongue T as required. The cover 1 is stretchable to envelop a tongue T, but when released contracts toward its original un-stretched shape. In use, the cover 1 is attached to the tongue T and improves the ability of the user to grasp that tongue T and arrange the seatbelt SB associated with the tongue T for his or her protection during a crash.

The body 10 has an external surface and an internal surface. The internal surface is a channel 11 that is accessed through an opening 12 in the body 10. The channel 11 is shaped and dimensioned to in use receive a tongue T. In use, the body 10 is stretched to allow the tongue T to be inserted through the opening 11 into the channel 12, and then the body 10 is released to elastically secure the cover 1 onto the tongue T.

FIG. 3 shows that the body 10 has a spine 13 from which first and second hooked portions 14, 15 extend. The spine 13 and hooked portions 14, 15 are dimensioned to allow the cover 1 to elastically fitted to a plastic part P of the tongue T, so that the cover 1 is hooked over the tongue T and held in place.

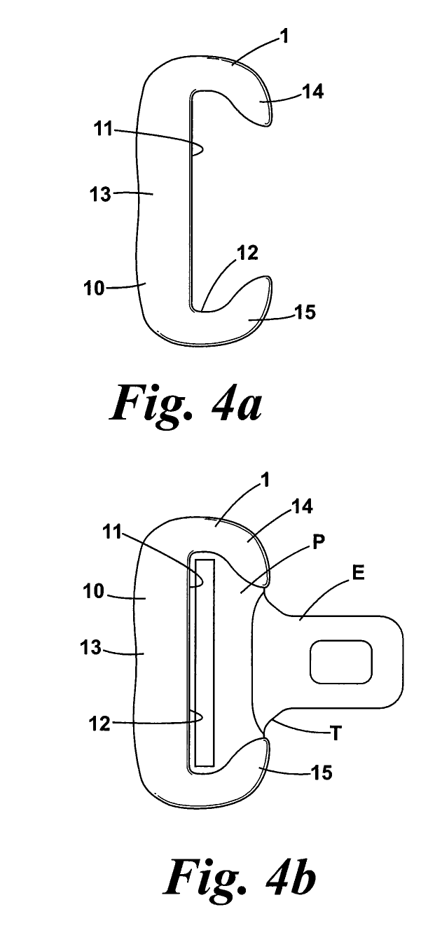

FIGS. 4a and 4b show how the cover is fitted to the tongue T. The cover 1 is selected by a user then stretched in preparation for attachment to the tongue T. The user inserts the tongue T through the opening 12 into the channel 11. The hooked portions 14, 15 are positioned around the ends of the tongue T. After the user has positioned the hooked portions 14, 15, and they are released to contract around the tongue T. The contraction of the hooked portions 14, 15 draws the cover 1 onto the tongue T, where it is held spin position as shown by FIG. 4b.

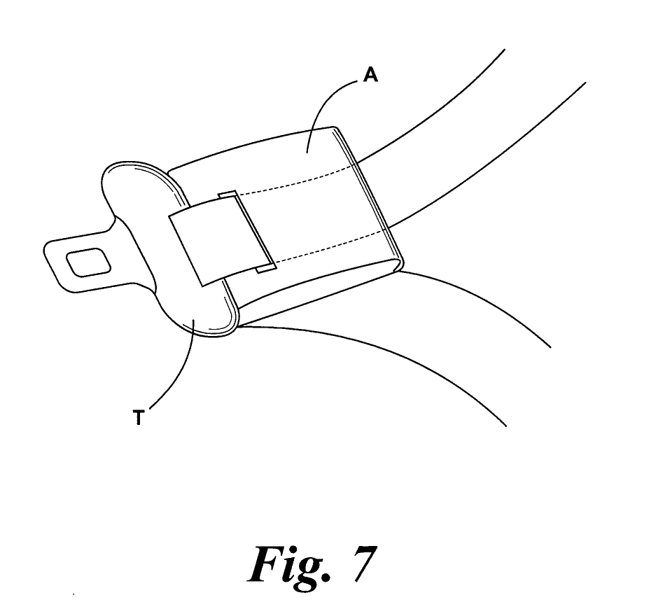

The example embodiments shown are intended to be fitted onto any standard size or shape of seat belt tongue. However, seat belt tongues can be modified or adapted by a user post-manufacture. The modification or adaptation of the seat belt tongue T can include the attachment of an additional part A, as shown by FIG. 7. The additional part A is, for example, used to tension the seat belt to hold the seat belt's user in position on the seat. Other embodiments of the cover (not shown) are adaptable so that body 10 and channel 11 are shaped and dimensioned to cover the part A as well as the tongue T.

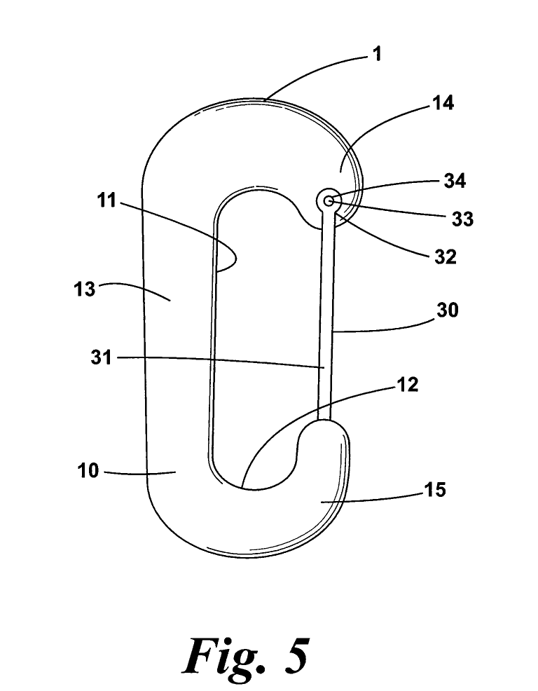

FIG. 5 shows a second embodiment of a cover of the present invention having all the features of the first embodiment and a securement means 30. The securement means 30 is a strap 31 and a fastening means 32. The strap 31 is located in an end region of one the hooked portion 15, and the fastening means 32 is located in an end region of the other hooked portion 14. The strap 31 is fitted to the fastening means 32, in use, after the cover has been fitted on the tongue. The securement means 30 provides and additional means for securing the cover to the tongue 7.

The fastening means is a combination of a protrusion 33 extending from the hooked portion 14 and an aperture 34 located at or near the distal end of the strap 31, i.e., the aperture 34 is located at the end of the strap 31 that is not attached to the hooked portion 15. In use, the strap 31 is secured by stretching and then slot-fitting the protrusion 33 into the aperture 34.

Although FIG. 5 shows only one strap 31 and fastening means 32, it is possible to provide more than one strap, for example two straps, one on either side of the cover 1.

After the cover 1 has been positioned on the tongue T, a user is able to grab the cover 1 to draw the webbing W across their body and insert the extension E into the buckle B. The cover 1 is fabricated from a rubbery or, suitable, pliable plastics material, such as silicone elastomers. The cover 1 is slightly squashed under the grasp of a user, which generates more friction between the user's fingers than would be the case with the normal hard plastic P of the known tongue T shown in FIG. 2. The increase of friction results in it being less likely that the tongue T will inadvertently slip from a user's grasp.

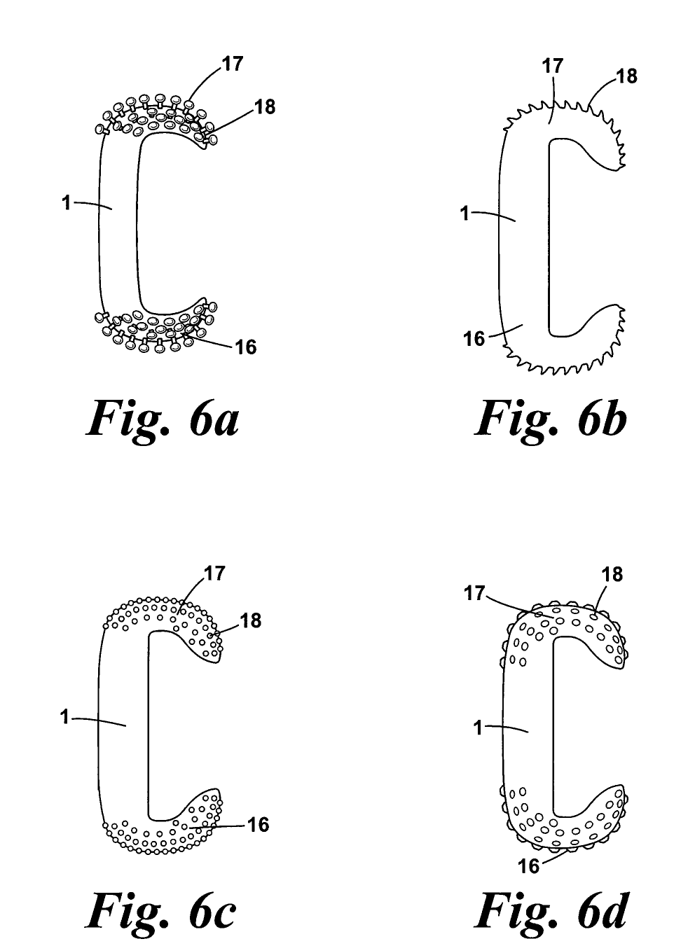

FIGS. 3, 4a, 4b and 5 show embodiments of the cover having a smooth external surface. FIGS. 6a to 6d show alternative embodiments of the cover having textured regions 16, 17 separated by a smooth region. The textured regions 16, 17 are provided to increase the friction between a user's fingers and the cover 1. The textured regions 16, 17 provide a roughened surface in the areas of the cover 1 that a user is likely to grasp when drawing the webbing W from the inertia reel I.

FIGS. 6a-6d show examples of patterns 18 comprising nodules, ribs, ridges and other protrusions that form the textured regions 16,17. The different exemplary patterns 18 are provided on the external surface of the cover 1. The patterns 18 provide a surface that allows a user to easily grasp and manipulate the covered tongue, making it easier to manipulate the tongue whilst reducing the potential for it to slip from a user's grasp.

FIG. 6a shows the pattern 18 as being a series of saw-tooth ridges or ribs on the edges of the cover 1.

FIG. 6b shows the pattern 18 as being a series of small nodules in the edge regions of the cover 1. The small nodules each form a rounded, hemispherical, protrusion.

FIG. 6c shows the pattern 18 as being a series of large nodules in the edge regions of the cover 1. The large nodules each form a raised protrusion.

FIG. 6d shows the pattern 18 as being a series of mushroom-shaped protrusions extending from the edge regions of the cover 1.

FIGS. 6a-6d also show a smooth region 18 that separates the textured regions 16, 17. The smooth region reduces the amount of friction produced between the webbing W and the tongue T as tongue T is moved relative to the webbing W.

In use, the protrusions will be compressed or squashed by the user's fingers as they are grasped. This ability to become squashed tends to flatten the protrusions relative to the body and increase the surface area that is manipulated by the user. This has the effect of increasing the friction generated between the covered tongue and the user's fingers. The increased friction results in it being less likely that a tongue will inadvertently be released from a user's grasp.

In a further exemplary embodiment (not shown), in addition to the features of the cover 1 described for the first, second and alternative embodiments, the cover 1 comprises a pressure activated system. The pressure activated system senses a user touching the cover and responds by emitting a voice sound such as the voice phrase “please ensure seat belt webbing is not twisted” and/or “please ensure the slack is taken out of the lap strap” through a speaker unit housed in the cover 1. The pressure activated system can also emit a light and/or cause the cover 1 to glow to indicate that the cover 1 has been touched. The pressure activated system provides a useful safety feature reminding a user of the importance of correctly fitting a seat belt.

With the cover 1 positioned, as shown by FIG. 4b, an easily cleanable surface is provided. The cover 1 can be washed in position on the tongue T. The cover 1 can also be removed from, washed and disinfected independently of the tongue T, before being repositioned. This ability allows the cover 1 to provide a surface that can be used to reduce the spread of diseases and infections.

To improve the cover's ability to minimize the spread of diseases and infections, the cover 1 is impregnated with a bactericidal substance, for example, ethyl alcohol.

The external surface of the body 10 is fabricated or coated with a fluorescent, luminous and/or reflective material to provide a covered tongue having increased visibility to a user. In this way, the cover 1 allows a user to more easily locate the tongue, especially at night.

The external surface of the cover 1, in an exemplary embodiment (not shown), is adapted to carry graphics or other decoration intended to appeal to young drivers. This adaptation may serve to encourage seat belt use and thereby reduce the likelihood of a serious injury being caused as a result of a crash.

The cover 1 is easy to fix to an existing tongue T and can be used to overcome various problems associated with the known tongues. Furthermore, the cover 1 is easy to fix in position and is able to be retrofitted to a whole fleet of cars, such as a fleet of hire cars.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A cover for a seat belt tongue, the cover comprising:
an elastically deformable body comprising means for holding the cover on at least part of the seat belt tongue.

2. The cover of claim 1, wherein the cover is adapted to cover at least part of the seat belt tongue and an attachment associated with the seat belt tongue.

3. The cover of claim 1, wherein the deformable body is stretched, in use, to be elastically fitted to at least part of the seat belt tongue.

4. The cover of claim 1, wherein the means for holding comprises at least a first hooked portion for hooking around the seat belt tongue to hold the cover in position.

5. The cover of claim 1, wherein the means for holding comprises a channel for receiving and holding the seat belt tongue.

6. The cover of claim 5, wherein, in use, the channel is arranged to hold an edge region of the seat belt tongue and at least one hooked portion is arranged to hold the opposite edge region of the seat belt tongue.

7. The cover of claim 1, wherein the means for holding comprises a securement means for, in use, holding the cover on the tongue.

8. The cover of claim 1, wherein the body has at least one textured region for being grasped by a user.

9. The cover of claim 8, wherein at least one textured region comprises a compressible element, the at least one compressible element being a protrusion extending from the body.

10. The cover of claim 1, wherein the cover comprises first and a second textured regions separated by a non-textured region.

11. The cover of claim 10, wherein the first and second textured regions are arranged in an edge region of the body; and
wherein, in use, the non-textured region is provided in region of the cover over which the webbing of seat belt will run when the cover is in place on a seat belt tongue.

12. The cover of claim 1, wherein at least part of the cover comprises a bactericidal substance.

13. The cover of claim 1, wherein the cover comprises one of a luminous body, a fluorescent body and a reflective body.

14. The cover of claim 1, wherein the cover has a pressure activated system; wherein the pressure activated system senses a user touching the cover; and
wherein, in use, the cover emits a sound in response to a user's touch being sensed, and/or the cover lights-up in response to a user's touch being sensed.

15. A seat belt tongue comprising a cover, the cover comprising:
a deformable body having means for holding the cover on the seat belt tongue; wherein
the body is elastically fitted to the seat belt tongue.

16. A method of covering a seat belt tongue, the method comprising the steps of:
selecting a cover having a deformable body, wherein the deformable body has means for holding the cover on the seat belt tongue; and
elastically fitting the deformable body to the seat belt tongue.

17. The method of claim 16, wherein the step of elastically fitting comprises:
hooking the cover around the tongue to hold the cover in position.

18. The method of claim 17, wherein the step of hooking comprises hooking at least one hooked portion of the body around the tongue.

19. The method of claim 16, wherein the step of elastically fitting comprises inserting the tongue into a channel provided in the body.

20. The method of claim 16, wherein the selected cover has a securement means to secure the cover to the seat belt tongue.
